(19) United States
(12) Patent Application Publication
(10) Pub. No.: US 2005/0194198 A1
(43) Pub. Date: Sep. 8, 2005

(54) Theft-proof device for car

(76) Inventor: Chiu-Yu Lin Chang, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/792,825

(22) Filed: Mar. 5, 2004

(51) Int. Cl. B60K 28/10

(52) U.S. Cl. 180/279

(57) ABSTRACT

A theft-proof device, in which a main machine and a receiver are provided on a car to cooperate with an emitter carried on an owner of the car, so that the main machine of the car activates a theft-proof mechanism when the emitter on the owner exceeds the distance for receiving signals and activates an alarm for asking rescue when the car is driven after being stolen or robbed with the ignition lock being turned on, and the ignition lock then is turned off to prevent the car from initiating, the theft-proof devices can thus develop the function of robbery-proofing and asking rescue.

### BACKGROUND OF THE INVENTION

1. Field of the Invention

The present invention is related to an electronic theft-proof device for a car, and especially to a theft-proof device with which a theft-proof mechanism is automatically activated when the owner of the car is a predetermined distance away from the car, thereby all the functions of the car will be locked forcedly.

2. Description of the Prior Art

Conventional theft-proof devices are signal emitters generally called remote controls carried by owners of cars for the convenience of activating or disabling alarm devices, so that the owners in a predetermined scope of distance away from the cars can activate or disable the alarms taking advantage of the signal emitters, and at the same time, the doors of the cars can be locked or unlocked, when the owners get in their cars, they can use the original keys to activate the cars.

Therefore, when an owner of a car stops his car and gets off, he must press down a theft-proof switch of an emitter, then the theft-proof mechanism of the car can be activated; but owners of cars often forget to activate the theft-proof mechanism of their cars because of some interference or negligence for a short while, and even they may-disable the theft-proof mechanism by advertently triggering the switches of their emitters, thereby the owners of the cars do not get access of and loss the normal theft-proof function after they leave their cars.

And more, although conventional theft-proof devices have the function of locking car doors within set times (normally within 10-20 seconds) after initiating cars in cooperating with activating of central locking systems, the cars are still probable to be robbed in the time interval when the owners of the cars get away of the cars and the cars have not yet been automatically locked after the theft-proof functions have been disabled, and even thieves directly invade the cars to expel the owners forcedly and drive the cars away; in such cases, the theft-proof devices can not develop their function of alarming, and particularly are unable to get effects of robbery-proofing by a more active measure.

### SUMMARY OF THE INVENTION

The electronic theft-proof device for a car of the present invention is provided therein in advance with a coded IC having therein initial internal codes obtained by burning, and a high-frequency emitting circuit for intermittently emitting weak high-frequency signals, the main machine of the theft-proof device has therein a memory provided by burning with initial internal codes, and is further provided therein with a microprocessor to check the signals on a receiver and the initial internal codes of the memory, and an alarm control loop is extended from a driving circuit to connect with an alarm, an electric current control loop is connected with the electric power source of a ignition lock of the car, if the main machine does not receive a signal from the emitter, it initiates the theft-proof mechanism.

Thereby, when an owner of the car stops the car and gets off and goes away for a predetermined distance, the main machine of the theft-proof device will activate the theft-proof mechanism by virtue that the emitter on the owner of the car exceeds the distance for receiving the signals.

Particularly, the theft-proof device is in a normal function of theft-proofing when the ignition lock is not yet turned on; when the car is driven after being stolen or robbed with the ignition lock being turned on, the main machine on the car will be unable to receive the signals from the emitter by the fact that the emitter has exceeded the distance for receiving the signals, it thereby immediately emits alarm for help, and thereby is unable to initiate the car at this time that the ignition lock has been turned off while the alarm function has not been disabled, it forcedly locks the functions of the car and gets the effect of rubbery proofing and rescue asking by a more active measure.

The present invention will be apparent in its structure and mode of operation after reading the detailed description of the preferred embodiment thereof in reference to the accompanying drawings.

### BRIEF DESCRIPTION OF THE DRAWINGS

FIG. 1 is a schematic view showing the arrangement in combination of the entire theft-proof device of the present invention;

FIG. 2 is an electric circuit diagram showing an emitter of the present invention;

FIG. 3 is an electric circuit diagram showing a receiver of the present invention;

FIG. 4 is an electric circuit diagram showing a main machine of the present invention.

### DETAILED DESCRIPTION OF THE PREFERRED EMBODIMENT

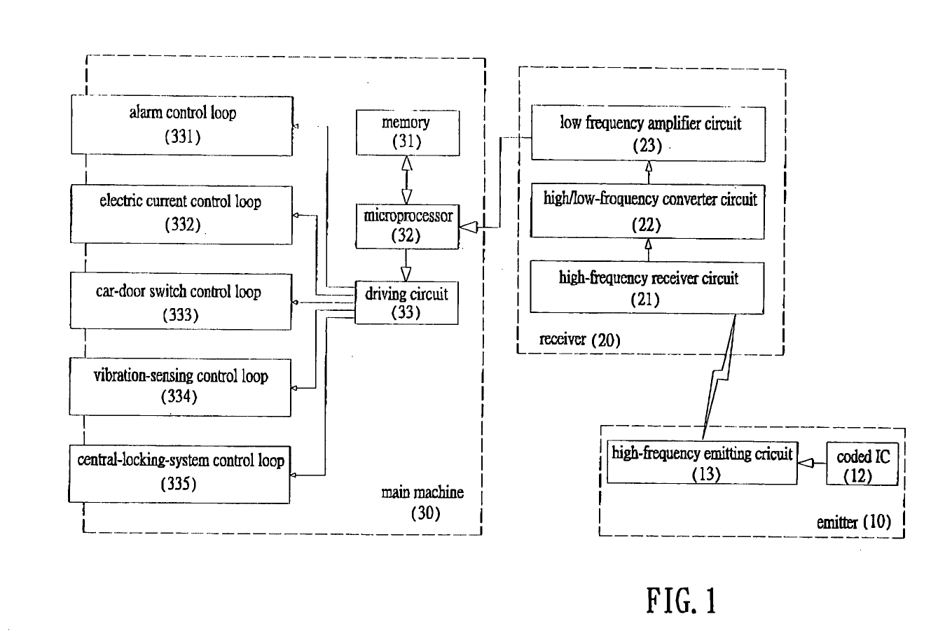

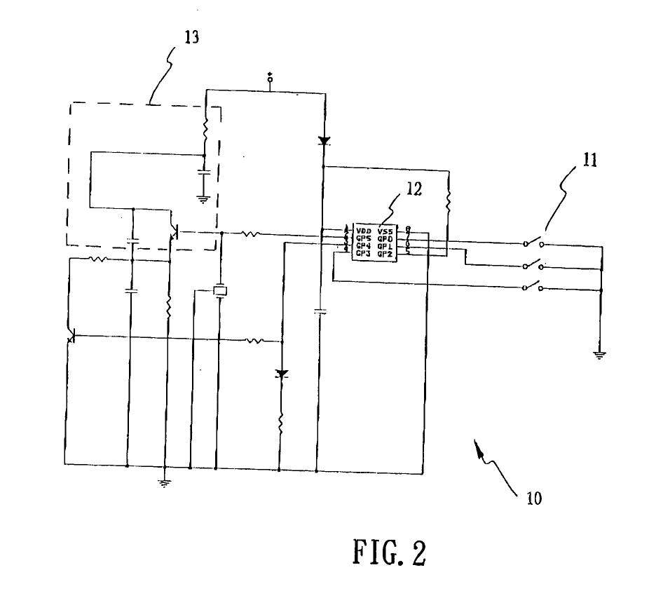

Referring FIG. 1, the arrangement in combination of the entire theft-proof device of the present invention is depicted in FIG. 1, basically it is comprised of an emitter 10 carrying on a car owner, a receiver 20 provided at a fixed position on the car, and a main machine 30. Referring simultaneous to FIG. 1 and 2, the emitter 10 is a member structurally convenient for carrying of the car owner, it is provided with an operating key 11, and is provided in advance therein with a coded IC 12 having therein initial internal codes obtained by burning, and a high-frequency emitting circuit 13 for intermittently emitting weak high-frequency signals; and it is provided further with a battery for operation of its circuit, so that the operating key 11 can activate/disable the theft-proof device, and can emit weak high-frequency signals normally intermittently every 5 seconds.

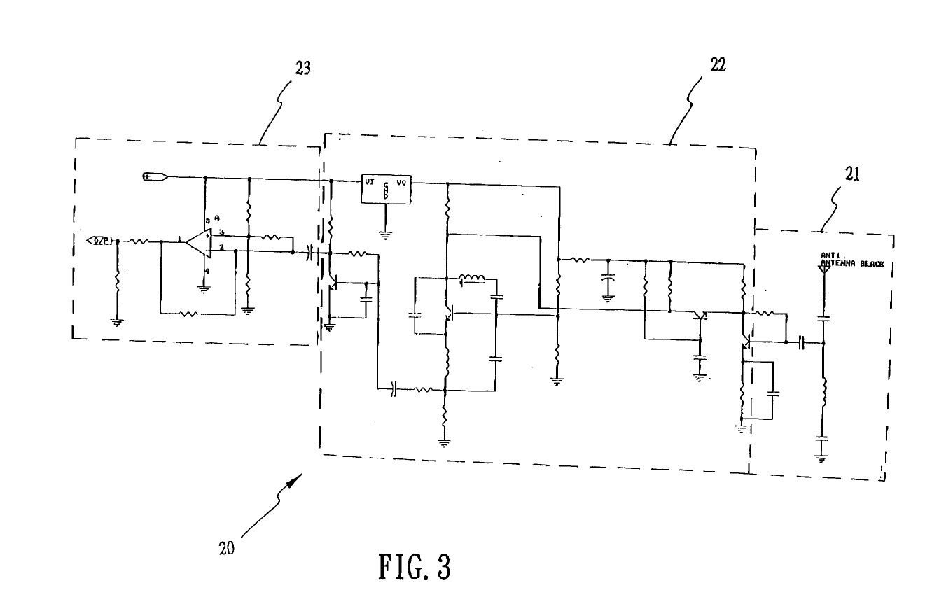

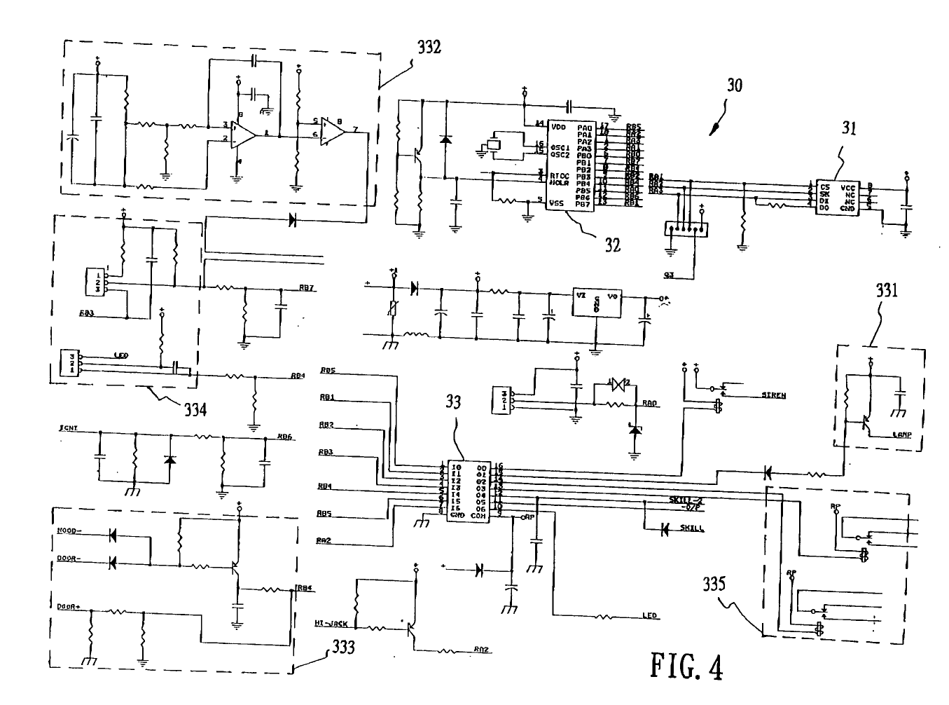

As shown in FIGS. 3 and 4, the receiver 20 and the main machine 30 are coordinatively provided at fixed positions on the car, wherein the receiver 20 is provided therein with a high-frequency receiver circuit 21 for receiving the signals from the emitter, a high/low-frequency converter circuit 22 and a low-frequency amplifier circuit 23. The main machine 30 is connected with the receiver 20 and the electric power of the car, it has therein a memory 31 provided by burning with initial internal codes, and is further provided therein with a microprocessor 32 to check the signals of the receiver 20 and the initial internal codes of the memory 31; surely the main machine 30 can also be provided with an indicating lamp and function keys to display the state of operation of the main machine 30 and for switching of functions.

The microprocessor 32 of the main machine 30 further is connected with a driving circuit 33, and an alarm control loop 331 is extended from the driving circuit 33 to connect with an alarm, an electric current control loop 332 is connected with the electric power source of a ignition lock of the car, the embodiment shown in the drawing further has a car-door switch control loop 333 extending to connect with the car doors of the car, a vibration-sensing control loop 334 to sense vibration of the car, a central-locking-system control loop 335 to automatically activate or disable the central locking system of the car in pursuance of the situation of the car, so that the theft-proof device can immediately initiate the alarm when the car door is unduly opened or the car is unduly moved and towed under the condition that the ignition lock has not been turned on and can present a normal operation state of having the theft-proof function.

When the owner of the car is desired to drive the car, the receiver 20 will receive the high-frequency signals from the emitter 10 because of getting close of the emitter 10; after that, it can convert and amplify the signals and input them to the main machine 30 for checking, it can automatically disable the theft-proof function and the central locking system when the signals are confirmed to be correct, thereby the owner can get in the car; and when the owner stops the car and gets off and goes away for a predetermined distance, the main machine of the theft-proof device will activate the theft-proof mechanism by virtue that the emitter on the owner of the car exceeds the distance for receiving the signals.

Moreover, when the car is driven after being stolen or robbed with the ignition lock being activated, the main machine on the car will be unable to receive the signals from the emitter by the fact that the emitter on the owner has exceeded the distance for receiving the signals, it thereby immediately emits alarm for help, and thereby is unable to initiate the car at this time that the ignition lock has been turned off while the alarm function has not been disabled, it forcedly locks the functions of the car and thereby the owner can seek the car. Certainly, when in the case that the car is suddenly robbed or out of order, the owner can directly press the operating key of the emitter to activate the alarm to make alarming, and thereby to get the effect of asking for help.

As is stated above, the present invention provides a better and practical theft-proof device, however, the embodiment given and the drawings shown are only for illustrating a preferred embodiment of the present invention and not for giving any limitation to the scope of the present invention; it will be apparent to those skilled in this art that various equivalent modifications or changes similar to the structure, arrangement as well as characteristics of this invention shall also fall within the scope of the appended claims.

1. A theft-proof device comprising:
an emitter being a member structurally convenient for carrying on a car owner, and being provided therein in advance with a coded IC having therein initial internal codes obtained by burning and a high-frequency emitting circuit for emitting intermittently weak high-frequency signals, and being provided further with a battery for operation of a circuit;
a receiver provided at a fixed position on said car and provided therein with a high-frequency receiver circuit for receiving signals from said emitter, a high/low-frequency converter circuit and a low-frequency amplifier circuit;
a main machine provided at a fixed position on said car and connected with said receiver and said electric power of said car, and having therein a memory provided by burning with initial internal codes, and further provided therein with a microprocessor to check said signals in said receiver and said initial internal codes said the memory; said microprocessor further is connected with a driving circuit, and an alarm control loop is extended from said driving circuit to connect with an alarm, an electric current control loop is connected with an electric power source of a ignition lock of said car; said main machine activates a theft-proof and alarming function to surely turn off said electric power source of said ignition lock when it receives no signal from said emitter within a set time; so that when a distance between said receiver and said emitter on said owner of said car exceeds that for receiving said signals, said theft-proof device is activated.

2. The theft-proof device as claimed in claim 1, wherein, said main machine is in a normal function of theft-proofing when said ignition lock is not yet turned on; when said car is driven after being stolen or robbed with said ignition lock being turned on, said main machine on said car is unable to receive said signals from said emitter by the fact that said emitter on said owner has exceeded said distance for receiving said signals, it thereby immediately emits said alarm for help, and thereby is unable to initiate said car at this time that said ignition lock has been turned off while said alarm function has not been disabled, it forcedly locks functions of said car and gets an effect of robbery proofing and rescue asking.

3. The theft-proof device as claimed in claim 1, wherein, said driving circuit of said main machine has a car-door switch control loop extending therefrom to connect with said car doors of said car, said alarm is immediately initiated when said car door is unduly opened.

4. The theft-proof device as claimed in claim 1, wherein, said driving circuit of said main machine has a vibration-sensing control loop extending therefrom to sense vibration of said car, said alarm is initiated when said car is unduly moved and towed.

5. The theft-proof device as claimed in claim 1, wherein, said driving circuit of said main machine has a central-locking-system control loop extending therefrom to automatically activate or disable a central locking system of said car in pursuance of the situation of said car.

6. The theft-proof device as claimed in claim 1, wherein, said main machine is provided with an indicating lamp and function keys to display state of operation of said main machine and for switching of functions.

7. The theft-proof device as claimed in claim 1, wherein, said emitter is provided with an operating key.
